(19) United States
(12) Patent Application Publication
(10) Pub. No.: US 2020/0188874 A1
(43) Pub. Date: Jun. 18, 2020

(54) A SORBENT AND A FILTER

(71) Applicant: SVENSKA AEROGEL AB, Gävle (SE)

(72) Inventors: Zareh TOPALIAN, Uppsala (SE); Peter NORBERG, Gävle (SE)

(73) Assignee: SVENSKA AEROGEL AB, Gävle (SE)

(21) Appl. No.: 16/609,376

(22) PCT Filed: Apr. 20, 2018
(86) PCT No.: PCT/SE2018/050405

§ 371 Date: Oct. 29, 2019

(30) Foreign Application Priority Data
May 3, 2017 (SE) 1750536-3

(51) Int. Cl. B01J 20/10; B01J 20/26; B01J 20/28; B01D 53/04; B01D 53/72; B01D 53/82

(52) U.S. Cl. CPC B01J 20/103; B01J 20/262; B01J 20/10; B01J 20/28061; B01D 53/04; B01D 53/72; B01D 2257/708; B01D 2251/402; B01D 2251/404; B01D 2253/106; B01D 2253/25; B01D 2253/202; B01D 53/82

(57) ABSTRACT

A sorbent for capture of formaldehyde, including a hydrophilic amorphous precipitated silica material having a BET surface area of at least 200 m2/g, and an organic compound in the form of polyethylenimine (PE I) bound to a surface of the amorphous precipitated silica material.

### TECHNICAL FIELD

The present invention relates to a sorbent for capture of formaldehyde. It further relates to a formaldehyde filter comprising such a sorbent, and to use of the proposed sorbent for capture of formaldehyde.

### BACKGROUND AND PRIOR ART

Formaldehyde (CH₂O) is a volatile organic compound (VOC) present in e.g. resins used in the manufacture of composite wood products, building materials, household products such as glue, paint, coatings, carpets, etc. Formaldehyde is considered to be a human carcinogen and exposure to increased levels of formaldehyde may be associated with long-term health risks. Formaldehyde is also associated with short term health effects, such as burning sensations in the eyes, nose, and throat, coughing, nausea, and skin irritation, which may arise also at modestly increased levels of exposure. It is therefore desirable to prevent off-gassing of formaldehyde from products containing the compound, or to otherwise reduce levels of formaldehyde in e.g. indoor environments. In particular, it is desirable to reduce levels of formaldehyde in formaldehyde-based resins industry, in which the highest potential exposure occurs.

Known methods for removing formaldehyde include the use of activated carbon filters and filters comprising potassium permanganate. However, it is desirable to provide an improved solution for removal of formaldehyde, which does not involve the use of potentially hazardous chemicals such as potassium permanganate.

### SUMMARY OF THE INVENTION

It is a primary object of the present invention to provide an in at least some aspect improved technology by means of which formaldehyde can be removed from environments in which it is present, such as from indoor and industrial environments and packaging. In particular, it is an object to provide such a technology which can remove formaldehyde relatively efficiently without the use of potentially hazardous chemicals such as potassium permanganate. Another object is to provide a sorbent for capture of formaldehyde which can be cost efficiently produced.

According to a first aspect of the invention, at least the primary object is achieved by means of a sorbent for capture of formaldehyde according to claim 1. The sorbent comprises:
a hydrophilic amorphous precipitated silica material having a BET surface area of at least 200 m²/g; and
polyethylenimine (PEI) bound to a surface of the amorphous precipitated silica material.

Sorbents according to the invention may be used to remove formaldehyde from various environments in which formaldehyde is present, also at relatively low concentrations. The sorbent may efficiently remove formaldehyde by means of chemisorption without the use of potentially hazardous chemicals. Thanks to the large BET surface area of the amorphous precipitated silica material, the PEI can be spread out over a large surface which thereby becomes active in the uptake of formaldehyde. The sorbent can furthermore be cost efficiently produced by means of mixing alkali silicate with a salt solution followed by ambient pressure drying, such as previously described in WO2006/071183, wherein the PEI may be added to and mixed with the precipitated silica after washing and dewatering, before final drying to obtain the sorbent in powder or granular form. Doping of the amorphous precipitated silica with PEI can thereby efficiently be included in the production process.

The polyethylenimine (PEI, (C₂H₅N)ₙ) is able to chemically react with formaldehyde and form a surface bound reaction product, thereby trapping it in the porous structure of the sorbent. Since the PEI acts so as to chemisorb formaldehyde, formaldehyde trapped within the sorbent is not released upon a change in e.g. temperature and/or formaldehyde concentration.

Preferably, the sorbent comprises no other organic compound than PEI. The amorphous precipitated silica material is therefore hydrophilic.

According to one embodiment, the amorphous precipitated silica material has a BET surface area of at least 300 m²/g, preferably of at least 400 m²/g. The relatively large BET surface area is beneficial for the adsorption efficiency of the sorbent and increases the formaldehyde uptake.

According to one embodiment, the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O. A method of manufacturing such an amorphous precipitated silica material has been previously described in WO2006/071183. The precipitated silica material according to this formula is known to have a relatively large BET surface area and can be manufactured with suitable pore sizes within the mesoporous range, i.e. 2-50 nm. The value of m may vary between 1-4, or preferably 2-3.7, such as m=3.35. The value of y may vary within the range 0.5-2, depending on the valences of the metals.

According to one embodiment, Me denotes Ca and Mg. A combination of Ca and Mg has proved to give good results in terms of BET surface area, pore size distribution and dopability of The silica material with the PEI. The molar ratio of Ca/Mg may e.g. be 35/65 or 32/68, but the molar ratio may of course be optimised to achieve a desired dopability with the PEI. Preferably, the molar ratio of Ca/Mg varies within the range 0.05<Ca/Mg<1.0.

According to one embodiment, the polyethylenimine is present within the sorbent in an amount of 1-40 wt. %.

According to one embodiment, the polyethylenimine is present within the sorbent in an amount of 1-20 wt. %.

According to one embodiment, the polyethylenimine is present within the sorbent in an amount of 5-20 wt. %.

According to one embodiment, the polyethylenimine is present within the sorbent in an amount of 5-12 wt. %.

In the above embodiments, the amount of PEI is given in percentage by weight (wt. %) of dry matter of the total sorbent weight. By including at least 1 wt. %, preferably at least 5 wt. %, desirable levels of formaldehyde adsorption may be achieved. By limiting the amount to 40 wt. %, preferably 20 wt. %, and more preferably 12 wt. %, negative effects on the BET surface area, the pore size and the mechanical strength of the sorbent can be avoided. By limiting the PEI to maximum 20 wt. %, all PEI can be bound to the surface within the internal pore structure of the sorbent, and the adsorption of formaldehyde can be particularly efficient.

The invention also relates to a formaldehyde gas filter comprising the proposed sorbent in accordance with any of the above described embodiments. The formaldehyde gas filter may comprise a gas permeable carrier for supporting the sorbent.

The present disclosure also relates to use of the proposed sorbent according to any one of the above described embodiments for capture of formaldehyde gas.

Further advantages as well as advantageous features of the present invention will appear from the following detailed description.

### BRIEF DESCRIPTION OF THE DRAWINGS

Embodiments of the invention will in the following be described with reference to the appended drawings, in which:

FIG. 1 shows formaldehyde uptake of sorbents according to embodiments of the invention and reference sorbents.

### DETAILED DESCRIPTION OF EMBODIMENTS OF THE INVENTION

A sorbent for capture of formaldehyde according to an embodiment of the invention comprises an amorphous precipitated silica material having the general formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O. The amorphous precipitated silica material may be in the form of a Quartzene® material of CMS type, which can be written as (Ca_{0.35},Mg_{0.65})O×3.35 SiO₂, i.e. Me=(Ca_{0.35},Mg_{0.65}), y=1 and m=3.35.

A method of manufacturing this material by mixing alkali silicate with a salt solution is disclosed in WO 2006/071183. The material is formed as a precipitate by mixing alkali silicate with a salt solution. The precipitate is thereafter processed in various ways to obtain an end product having desired properties in terms of pore size, particle size, surface area, density, etc. The amorphous precipitated silica material used for the sorbent according to embodiments of the invention has a mesoporous structure with a BET surface area of at least 200 m²/g, preferably of at least 300 m²/g or more preferably of at least 400 m²/g.

The amorphous precipitated silica material is doped with an organic compound in the form of polyethylenimine (PEI) bound to a surface of the amorphous precipitated silica material. The combination of PEI and amorphous precipitated silica has according to the present invention been found to be beneficial for the capture of formaldehyde. The PEI is preferably present within the sorbent in an amount of 1-40 wt. %, more preferably in an amount of 1-20 wt. %, and even more preferably in an amount of 5-20 wt. %, and most preferably in an amount of 5-12 wt. %. However, the suitable amount of PEI depends on e.g. the available BET surface area of the amorphous precipitated silica material as well as the pore size of this material.

The sorbent according to the invention may advantageously be included in a formaldehyde gas filter, intended to remove formaldehyde from various environments in which formaldehyde is present, also at relatively low concentrations such as less than 0.5 ppm or less than 1 ppm. The sorbent may for this purpose be supported on a gas permeable carrier, such as in a filter cassette. A fan may be provided for forcing polluted air through the formaldehyde gas filter.

### EXAMPLES

A number of exemplary formaldehyde sorbents according to embodiments of the invention, S1-S3, were manufactured and tested together with test samples T1-T7 and reference prior art sorbents, Ref1-Ref2. The tested sorbents are listed in Table I.

TABLE I

| Sample | Description |
|---|---|
| S1 | 40 wt. % PEI on precipitated silica |
| S2 | 5 wt. % PEI on precipitated silica |
| S3 | 20 wt. % PEI on precipitated silica |
| T1 | 10 wt. % triisopropanolamine on precipitated silica |
| T2 | 10 wt. % (3-Aminopropyl) triethoxysilane on |
| | precipitated silica |
| T3 | 5 wt. % urea on precipitated silica |
| T4 | 10 wt. % urea on precipitated silica |
| T5 | 20 wt. % polyethylenoxide on precipitated silica |
| T6 | 8 wt. % PEI on hydrophobized precipitated silica |
| T7 | Non-doped precipitated silica (hydrophilic) |
| T8 | Hydrophobized precipitated silica |
| Ref1 | Activated carbon (Jacobi) |
| Ref2 | Commercial CamPure ® adsorbent from Camfil |

The amorphous precipitated silica material of S1-S3, T1-T5 and T7 was a CMS type Quartzene® material. The amorphous precipitated silica material of the sorbent samples S1, S2 and S3 and the test samples T1-T5 and T7 was prepared in accordance with the method described in WO 2006/071183, wherein calcium and magnesium sources were added to a dilute active aqueous sodium silicate solution. A salt solution, comprising MgCl₂ and CaCl₂), was prepared at a ratio of 68 mol % Mg and 32 mol % Ca. The salt solution was poured onto the 1.5 M (with respect to SiO₂) sodium silicate solution, and the resulting mixture was agitated at room temperature. Subsequent coagulation occurred and the slurry formed was thereafter washed and dewatered on a filter cloth by means of vacuum suction to become a cake or gel.

The amorphous precipitated silica material of samples T6 and T8 was prepared analogously but was functionalised using a functional group to obtain a hydrophobic surface.

For the samples S1-S3 and T6, a dilute solution comprising PEI was added to the obtained gel. After thorough mixing, the PEI doped gel was dried to obtain the sorbent in powder or granular form. In an analogous way, solutions containing the other listed compounds were added to the obtained gel to obtain the samples T1-T5.

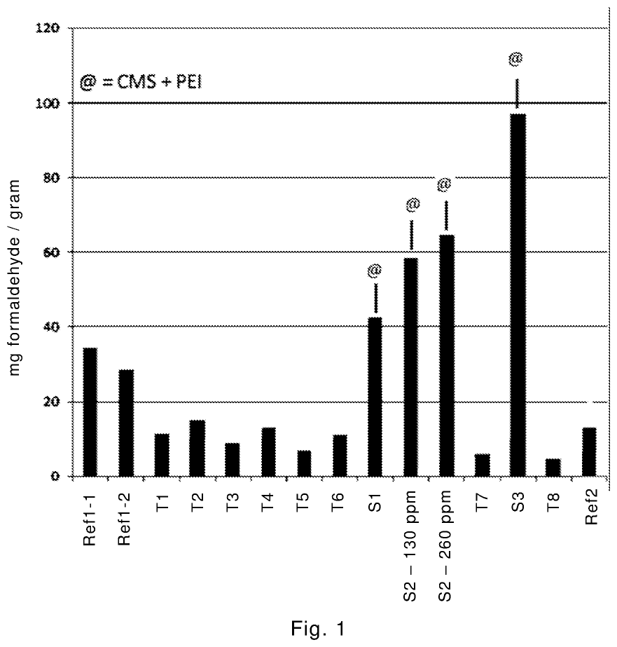

The total formaldehyde uptake in mg formaldehyde per gram sorbent for the different tested samples is shown in FIG. 1. All tests were performed by passing air containing formaldehyde at a concentration of 260 ppm through the sorbent. Sample S2 containing 5 wt. % of PEI was also tested at a formaldehyde concentration of 130 ppm. The volume flow of air was 0.9 l/min. The reference sample Ref1 was tested twice with slightly different measurement procedures and the results are shown as Ref1-1 and Ref1-2.

As can be seen from FIG. 1, all samples containing PEI loaded on hydrophilic amorphous precipitated silica exhibit relatively high formaldehyde uptakes in comparison with the test samples T1-T8 and the reference samples Ref1 and Ref2. The sample S3 containing 20 wt. % PEI on CMS type Quartzene® material shows the best results in terms of formaldehyde uptake of more than 90 mg adsorbed formaldehyde per gram sorbent. Also the sample S2, comprising 5 wt. % PEI, shows a high uptake of formaldehyde of around 60 mg per gram sorbent. The sample S1 containing 40 wt. % PEI shows a somewhat lower uptake of around 40 mg per gram sorbent, which is however more than the uptake of the reference samples Ref1 and Ref2. A comparison between the hydrophobic sample T6 and the samples S2 and S3 indicate that the hydrophilic nature of the amorphous precipitated silica material is important for achieving a high formaldehyde uptake.

To summarize, the experimental results show that all sorbents S1-S3 can function for capture of formaldehyde at ambient conditions for the tested concentrations. It is expected that they will likewise be efficient sorbents for formaldehyde at lower concentrations, such as at 1 ppm or less.

The invention is of course not in any way restricted to the embodiments described above. On the contrary, many possibilities to modifications thereof will be apparent to a person with ordinary skill in the art without departing from the basic idea of the invention such as defined in the appended claims.

1. A sorbent for capture of formaldehyde, comprising:
a hydrophilic amorphous precipitated silica material having a BET surface area of at least 200 m²/g; and
an organic compound in the form of polyethylenimine (PEI) bound to a surface of the amorphous precipitated silica material.

2. The sorbent according to claim 1, wherein the amorphous precipitated silica material has a BET surface area of at least 300 m²/g.

3. The sorbent according to claim 1, wherein the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

4. The sorbent according to claim 3, wherein Me denotes Ca and Mg.

5. The sorbent according to claim 1, wherein the polyethylenimine is present within the sorbent in an amount of 1-40 wt. %.

6. The sorbent according to claim 1, wherein the polyethylenimine is present within the sorbent in an amount of 1-20 wt. %.

7. The sorbent according to claim 1, wherein the polyethylenimine is present within the sorbent in an amount of 5-20 wt. %.

8. The sorbent according to claim 1, wherein the polyethylenimine is present within the sorbent in an amount of 5-12 wt. %.

9. A formaldehyde gas filter comprising the sorbent according to claim 1.

10. A method, comprising using the sorbent according to claim 1 for capture of formaldehyde.

11. The sorbent according to claim 1, wherein the amorphous precipitated silica material has a BET surface area of at least 400 m²/g.

12. The sorbent according to claim 2, wherein the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

13. The sorbent according to claim 2, wherein the polyethylenimine is present within the sorbent in an amount of 1-40 wt. %.

14. The sorbent according to claim 3, wherein the polyethylenimine is present within the sorbent in an amount of 1-40 wt. %.

15. The sorbent according to claim 4, wherein the polyethylenimine is present within the sorbent in an amount of 1-40 wt. %.

16. The sorbent according to claim 2, wherein the polyethylenimine is present within the sorbent in an amount of 1-20 wt. %.

17. The sorbent according to claim 3, wherein the polyethylenimine is present within the sorbent in an amount of 1-20 wt. %.

18. The sorbent according to claim 4, wherein the polyethylenimine is present within the sorbent in an amount of 1-20 wt. %.

19. The sorbent according to claim 5, wherein the polyethylenimine is present within the sorbent in an amount of 1-20 wt. %.

20. The sorbent according to claim 2, wherein the polyethylenimine is present within the sorbent in an amount of 5-20 wt. %.
